(19) United States
(12) Patent Application Publication
(10) Pub. No.: US 2009/0290781 A1
(43) Pub. Date: Nov. 26, 2009

(54) ILLUMINATING DEVICE FOR CYLINDRICAL OBJECTS, SURFACE INSPECTION METHOD IMPLEMENTED THEREWITH AND COMPUTER PROGRAM PRODUCT

(75) Inventors: Caulier Yannick, Furth (DE); Spinnler Klaus, Erlangen (DE); Couronne Robert, Erlangen (DE)

Correspondence Address: INGRASSIA FISHER & LORENZ, P.C., 7010 E. COCHISE ROAD, SCOTTSDALE, AZ, 85253, US

(73) Assignee: Fraunhofer-Gesellschaft zur Forderung der angewandten Forschung e.V., Munich (DE)

(21) Appl. No.: 12/280,524

(22) PCT Filed: Feb. 22, 2007
(86) PCT No.: PCT/DE2007/000340

§ 371 Date: Jan. 14, 2009

(30) Foreign Application Priority Data
Feb. 25, 2006 (DE) 102006008840.9

(51) Int. Cl. G01N 21/88; G03B 15/02; G06K 9/00

(52) U.S. Cl. 382/141; 362/11; 356/239.4

(57) ABSTRACT

An illuminating device is provided that includes, but is not limited to a cylindrical lighting unit with a cylindrical slit diaphragm arranged in the interior thereof. The lighting unit includes, but is not limited to a cylindrical light source with a cylindrical diffusor arranged therein, and the slit diaphragm has a cylinder with axially extending slits that are arranged in such a way that incident beams coupled in perpendicular to the slit diaphragm axis (O) converge in a point (M) that is spaced apart from the cylinder axis in the interior of the slit diaphragm through the slits.

### CROSS-REFERENCE TO RELATED APPLICATIONS

This application is a U.S. National-Stage entry under 35 U.S.C. § 371 based on International Application No. PCT/DE2007/000340, filed Feb. 22, 2007, which was published under PCT Article 21(2) and which claims priority to German Application No. 102006008840.9, filed Feb. 25, 2006, which are all hereby incorporated in their entirety by reference.

### TECHNICAL FIELD

The invention pertains to an illuminating device for cylindrical objects.

### BACKGROUND

Industrial image processing deals with, among other things, the automated inspection of metal components that may have any surface characteristics and shapes. The defects detected during this inspection can be categorized into two basic types of defects: contaminations and deformations of the surface. Typical examples if defects are cavities, scratches, indentations, dots, dirt accumulations and abrasions.

During the automated inspection, photographs of the metallic components are taken with one or more cameras under an adapted illumination. The entire surface of the metal component can be inspected in this fashion. Subsequently, mathematical methods are used for automatically detecting defects in the surface images. It should be possible to distinguish surface areas that contain defects from defect-free areas in the best possible fashion. In this context, shiny surfaces are more challenging with respect to the selection and arrangement of suitable illumination components.

It is known to control cylindrical metallic components with non-destructive test methods, in which electromagnetic fields or ultrasonic waves are utilized. This makes it possible to detect internal and external cracks in the cylinders. For example, U.S. Pat. No. 5,408,104 discloses a method for inspecting cylindrical metal components, in which an annular fluorescent light source is used.

DE 101 39 589 A1 describes an arrangement for the diffuse illumination of a space by means of a light source that consists of several LEDs.

The invention aims to make available an illuminating device, a surface inspection method and a corresponding computer program product that make it possible to detect surface defects of cylindrical objects. In addition, other aims, desirable features and characteristics will become apparent from the subsequent summary and detailed description and the appended claims, taken in conjunction with the accompanying drawings and this background.

### SUMMARY

This objective, other objectives, desirable features and characteristics, are attained with An illuminating device. This illuminating device comprises a cylindrical lighting unit with a slit diaphragm arranged in its interior. The lighting unit comprises a cylindrical light source such as, e.g., a halogen lamp with a cylindrical diffusor arranged therein, and the slit diaphragm consists of a cylinder with axially extending slits. The slits are arranged in the cylinder in such a way that lines extending perpendicular to the axis of the cylinder or the slit diaphragm converge in a point that is spaced apart from the cylinder axis in the interior of the slit diaphragm through the slits.

During its operation, the cylindrical light source with the diffusor arranged therein generates a diffuse radiation that initially illuminates the slit diaphragm homogeneously. The object to be inspected is situated within the cylindrical slit diaphragm. This object is itself realized cylindrically and arranged coaxially to the light source. Part of this diffuse radiation is emitted through the slits of the slit diaphragm and reflected by the object to be inspected, for example, a metallic and therefore also shiny cylindrical object. Due to the utilization of a radiation coupling that is not realized perpendicular to the cylinder axis; the reflected radiation can be decoupled in the form of a parallel beam cluster and detected by a detector in the form of a strip pattern consisting of bright and dark strips.

The radiation decoupled from the illuminating device naturally is diffuse radiation. If this radiation would be incident on a perfectly curved surface, the reflected radiation would result in a strip pattern with dark and bright strips on a projection screen. In this case, the bright strips would represent a nominal brightness and a nominal geometry. The bright strips would be equidistant to one another. In this context, it should be noted that the projection screen does not form part of the illuminating device, but rather serves as a mere imaginary aid in order to characterize the nature of the radiation.

In an evaluation of such strip patterns of non-perfect surfaces, deviations from the aforementioned ideal strip pattern are detected. If the object being inspected features a contamination, this manifests itself in the form of a change of the local reflectivity and in the form of a deviation of the strip brightness from a nominal brightness. In this respect, an evaluation of the strip brightness makes it possible to deduce whether contaminations are present. If the object being inspected features local surface deformations, these deformations respectively have a certain height or depth and cause a local change of the surface normal in comparison with a plane surface. The curvature of the bright strips changes in dependence on the value of this parameter. An evaluation of the strip geometry therefore makes it possible to deduce if deformations are present. In this context, it should be noted that both aforementioned deviations may occur simultaneously in one and the same strip pattern. Consequently, both types of defects can be optically detected simultaneously with the proposed illuminating device and usually identified in a computer-assisted fashion.

The illuminating device has a compact structural shape and only requires a few components such that the manufacturing costs are correspondingly low. The device can operate with radiation in the visible range such that the illuminating device can be used as a supplement to known non-destructive optical inspection methods.

One embodiment of the illuminating device features a lighting unit with at least three cylindrical light sources that are arranged within one another. A lighting unit of high luminous intensity can be easily and inexpensively realized in this fashion by selecting light sources with high luminous efficiency. The light sources may consist of halogen lamps or annular LED lighting units. In order to achieve an acceptable inspection speed for the objects to be inspected, the luminous intensity should be at least 230.000 lux, preferably at least 250.000 lux.

According to another embodiment of the illuminating device, it is proposed to utilize a diffusor consisting of at least three cylindrical, opaque plastic and/or glass bodies that are arranged within one another. This makes it possible to produce diffuse radiation in a simple and particularly inexpensive fashion. The plastic and/or glass bodies may either be realized opaque or feature a roughened surface that may be produced (e.g., by means of sand blasting).

In another embodiment of the illuminating device, the lighting unit and the slit diaphragm are arranged coaxially to one another. This geometrically adapted illumination results in a uniformly illuminated surface of the object to be inspected if this object is also cylindrical. A uniformly diffuse illumination provides adequate measuring results on reflecting or shiny objects to be inspected because very different gray scale values may occur on object surfaces with identical characteristics depending on the position of the object to be inspected. In this respect, this geometrically adapted illumination allows the inspection of shiny surfaces of cylindrical objects and, for example, metallic objects to be inspected.

One embodiment of the illuminating device features a slit diaphragm with a wall thickness of at least 3 mm. At a smaller wall thickness of the slit diaphragm, more stray light reaches the detector acquiring the strip pattern, wherein a greater wall thickness cannot contribute to a noteworthy reduction of the stray light portion.

One embodiment of the illuminating device features a stray light shield arranged outside the lighting unit. This prevents a glare of the strip pattern being acquired, for example, by means of a line scan camera such that the strip pattern is visible more clearly and richer in contrast.

Another aspect of the invention concerns a lighting unit for the diffuse illumination of a cylindrical object to be inspected. The lighting unit comprises a cylindrical light source such as a halogen lamp with a cylindrical diffusor coaxially arranged therein, for example. Due to the choice of a cylindrical halogen lamp, one has the option of simultaneously realizing a high luminous efficiency and a long service life. Instead of providing a single light source, it would also be possible to use several light sources, particularly at least three light sources, which are arranged within one another in order to easily and inexpensively realize a lighting unit of high luminous intensity. In this case, it is also possible to choose a diffusor that consists of at least three opaque plastic and/or glass bodies that are arranged coaxially to one another.

Another aspect of the invention concerns a slit diaphragm consisting of a cylinder with axially extending slits. The slits are arranged in such a way that imaginary lines through the slits that extend perpendicular to the slit diaphragm axis converge in a point M that is spaced apart from the cylinder axis in the interior of the slit diaphragm. During the operation, the object to be inspected is situated in the interior of the strip diaphragm such that diffuse light can be incident thereon obliquely to the cylinder axis and a parallel beam cluster can be decoupled from the cylinder. As mentioned above, this illumination can be used for detecting deformations on the surface of the object to be inspected.

Another aspect of the invention concerns a method for detecting defects on the surface of a cylindrical object. In this method, the object to be inspected is subjected to radiation that is able to produce a pattern of mutually adjacent bright and dark strips on a projection screen or, equivalently thereto, on a camera sensor. In this case, the radiation may consist of the radiation generated by the above-described illuminating device. The radiation reflected by the object surface is detected in a spatially resolved fashion and the measured values are acquired in the form of an image. For example, a pixel may be assigned to each spatial area during the detection such that the entirety of all pixels represents the image. A multitude of characteristics is calculated for each pixel of the image or only a portion of these pixels. A characteristic may consist of geometric information linked to the pixel or a physical parameter linked to the pixel. Subsequently, pixels with a characteristic value that lies above and/or below a predetermined threshold value are identified. This is usually carried out for all calculated characteristics. Image areas, in which the identified pixels exceed a predetermined density, are then determined. In this case, each image area represents a section of the image and, accordingly, a portion of the surface of the object to be inspected that possibly contains a defect. In a last step, a defect or a defective area is identified in that the image areas belonging to at least two different characteristics adjoin sufficiently close at the respective location.

The aforementioned method makes it possible to identify surface defects with a high insensitivity to artifacts and to distinguish surface contaminations (e.g., paint splatters on the surface) from deformations (e.g., scratches). If the characteristics are chosen accordingly, it is also possible to distinguish between the respective type of deformation and the respective type of contamination.

According to one embodiment, the aforementioned method can be carried out in such a way that characteristics are only calculated for the pixels that are subjected to radiation with a minimum intensity. For example, it would be possible and usually suffices in practical applications to only calculate characteristics for the pixels that form the bright strips of the acquired strip pattern. The computing time can be significantly reduced in this fashion.

In one embodiment, it is furthermore proposed that the selected characteristic consists of the distance of the respective pixel from a selected point of the image, the detected radiation intensity at the pixel, the deviation of position between the pixel and a reference point within a mask placed over the image and/or the distance between two bright or dark strips from one another. In the first instance, the selected point may consist of the origin of a coordinate system, in which one axis, e.g., the x-axis, extends perpendicular to the strips and the correspondingly perpendicular y-axis extends in the direction of the strips. In the third instance, the image is evaluated with a mask, (i.e., a predetermined image area of, for example, 100×100 pixels) wherein the reference point may lie in the center of the mask.

In another embodiment, the method is carried out by using characteristics, the values of which only change due to contaminations on the object surface, or by using characteristics, the values of which can only change due to deformations on the object surface. Depending on the selected characteristics, this makes it possible to distinguish between two-dimensional (2D) and three-dimensional (3D) defects. For example, a defect can be identified as a 3D-defect by selecting characteristics, the value of which does not or at least not considerably change in case of a 3D-defect, but not in case of a contamination. Accordingly, a defect can be identified as a 2D-defect if characteristics are chosen, the value of which does not or at least not considerably change in case of a 2D-defect.

In one embodiment, it is furthermore proposed that the presence of a deformation of the object surface is deduced or a deformation is detected as a defect if one of the assigned characteristics is the deviation of position between the pixel and a predetermined reference point within a mask placed over the image when overlapping the image areas. In the sense of the last paragraph, this characteristic only changes considerably at pixels that lie in a deformation area (e.g., in a scratch). However, if the pixel is situated in a contaminated area, this characteristic is only subject to minimal changes.

Another aspect of the invention concerns a computer program product on a computer-readable medium that serves for carrying out the above-described method for detecting defects on the surface of a cylindrical object. The computer-readable medium such as, for example, a CD or a DVD comprises computer-readable program means that lead a computer to evaluate an image consisting of bright and dark strips that was acquired, for example, with the aid of the above-described illuminating device and therefore reflected by a cylindrical object to be inspected. The program means specifically lead the computer to calculate a multitude of characteristics for each pixel of the image or a portion of the pixels of the image consisting of a pattern of mutually adjacent bright and dark strips. The computer then identifies pixels, at which the value of at least one characteristic lies above and/or below at least one predetermined threshold value, as well as image areas, in which the identified pixels exceed a predetermined density. Such an image area represents a section of the image that possibly contains a defect. The defect is identified or the image area is identified as a defective area in that the image areas belonging to two different characteristics adjoin sufficiently close at the respective location.

In another embodiment, the computer program is designed to only calculate characteristics for pixels that were subjected to radiation with a minimum intensity. This makes it possible, for example, to only calculate characteristics for the pixels that belong to the bright strips of the strip pattern such that the computing time is reduced accordingly.

In one embodiment, the computer program may furthermore be designed such that the defect is identified as a contamination or as a deformation of the object in dependence on the characteristics.

### BRIEF DESCRIPTION OF THE DRAWINGS

The present invention will hereinafter be described in conjunction with the following drawing figures, wherein like numerals denote like elements, and

FIGS. 1a, 1b show an embodiment of a lighting unit for realizing diffuse illumination;

FIG. 2 shows an embodiment of a slit diaphragm;

FIG. 3 shows a top view of an embodiment of an illuminating device;

FIGS. 4a, 4b show a side view of one embodiment of an illuminating device;

FIGS. 5a-5d show photographed strip patterns of a metallic surface;

FIG. 6 shows a flow chart of the method for detecting defects on the surface of a cylindrical object; and

FIG. 7 shows photographed strip patterns.

### DETAILED DESCRIPTION

The following detailed description is merely exemplary in nature and is not intended to limit application and uses. Furthermore, there is no intention to be bound by any theory presented in the preceding summary and background or the following detailed description.

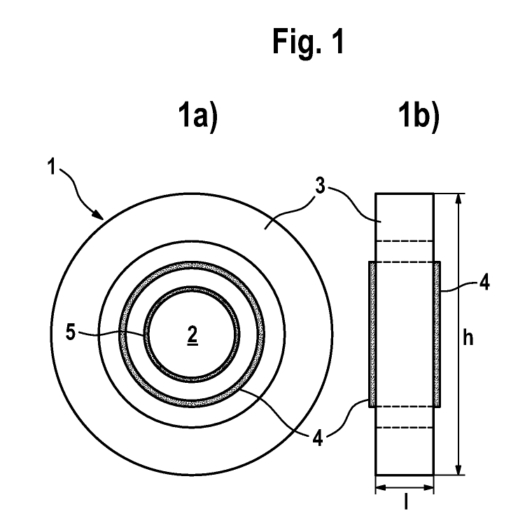

In the drawings, in which identical objects are identified by the same reference symbols, FIGS. 1a and 1b show an embodiment of a cylindrical and almost annular lighting unit 1, namely viewed in the direction of the cylinder axis in FIG. 1a) and in the direction perpendicular to the cylinder axis in FIG. 1b. The dimensions of the lighting unit can be largely chosen arbitrarily and depend on the radius of the cylindrical object to be inspected that is positioned in the core area 2. In the example shown, the light source 3 has an outside diameter h=200 mm.

The light source 3 consists of six individual (not-shown) light sources in all. They were selected with consideration of a long service life, a high luminous efficiency, a compact design and a high scattering ability. The light sources respectively consist of a halogen lamp with the item number DDL/01 of the firm Philips. They are operated with 20 V, have a power of 150 W and a lamp socket of the type GX 5,3. A cylindrical diffusor 4 is arranged coaxially to the light source 3. It consists of several opaque (not-shown) glass bodies that are positioned within one another, e.g., 8 glass bodies. Alternatively, it would be possible to use semitransparent plastic bodies. The diffusor has a wall thickness of 23 mm in the example shown, and the number of glass bodies is adapted to the luminous intensity and the opaqueness of the glass.

The cylindrical object 5 to be inspected is situated in the interior of the diffusor 4. The light source 3 and the diffusor 4 have the same geometry as the object 5 to be inspected (i.e., they are adapted to the cylindrical geometry of the object 5 to be inspected). The diffusor 4 serves for uniformly distributing the radiation of the light source 3 over the surface of the object 5 to be inspected.

The diffuse radiation of the lighting unit 1 serves for detecting contaminations on the surface of the object 5 to be inspected. The diffuse radiation is reflected by the surface of the object and can be detected with large-surface LED-arrays or a line scanning camera. Alternatively, it is possible to operate with indirect illumination that is realized with the aid of screens.

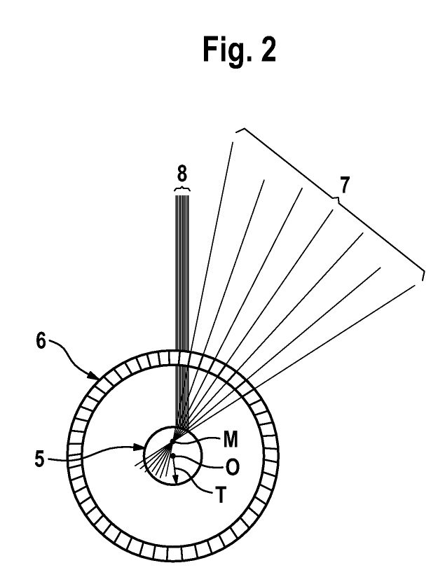

FIG. 2 shows an embodiment of a slit diaphragm 6. The cylindrical slit diaphragm 6 with slits extending in the longitudinal direction of the cylinder consists of aluminum or zirconium and is diffusely illuminated (in a not-shown fashion) during the operation of the device. The light beams 7 of the diffuse illumination that are incident through the slits are aligned due to the slit geometry in such a way that they converge in a point M when an object 5 to be inspected is present in the interior of the slit diaphragm 6. The position of the point M is adapted to the diameter r of the object 5 to be inspected.

The object 5 to be inspected has an axis that extends perpendicular to the plane of projection of the figure and through the point O. If an object 5 to be inspected is introduced coaxially, the distance between the point O and the point M is smaller than the radius r. The incident beams 7 are reflected on the surface of the object 5 to be inspected. Since they are coupled in obliquely to the axis extending through the point O and therefore obliquely to the plane of projection of the figure, the emergent beams 8 can be decoupled in the form of a parallel beam cluster at the rear end of the slit diaphragm 6.

During a measurement, the object 5 to be inspected is axially displaced with a speed of approximately (50+/−5) cm/s and the reflected beams 7 are detected with a clock rate of 5000/sec, i.e., 5000 lines (of the detector) per second. This speed was only possible with the high luminous intensity that was measured at 270.000 lux.

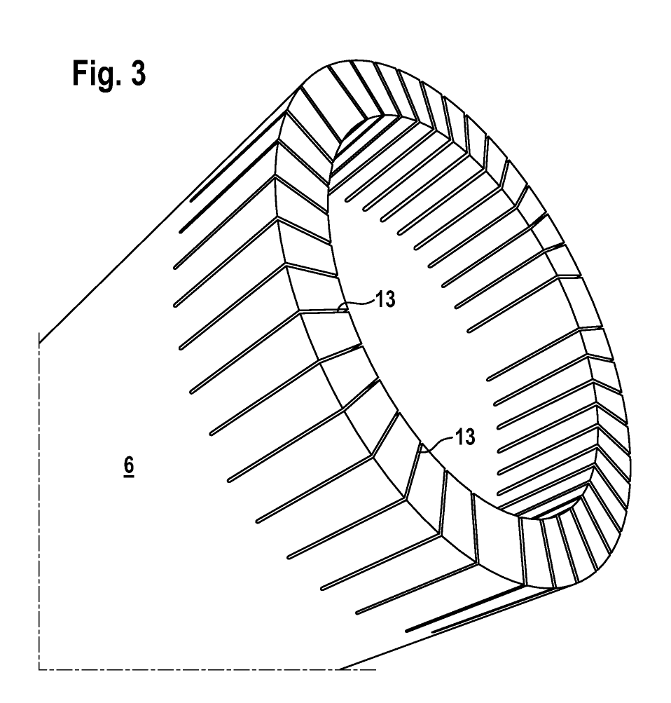

FIG. 3 shows an embodiment of an illuminating device 9. The cylindrical lighting unit 1, namely the lighting unit of the embodiment according to FIG. 1, illuminates the slit diaphragm 6. This slit diaphragm consists of a slit diaphragm according to FIG. 2. The lighting unit 1 and the slit diaphragm 6 are both realized cylindrically and arranged coaxially to one another. FIG. 3a shows a view of this arrangement in the longitudinal direction of the cylinder.

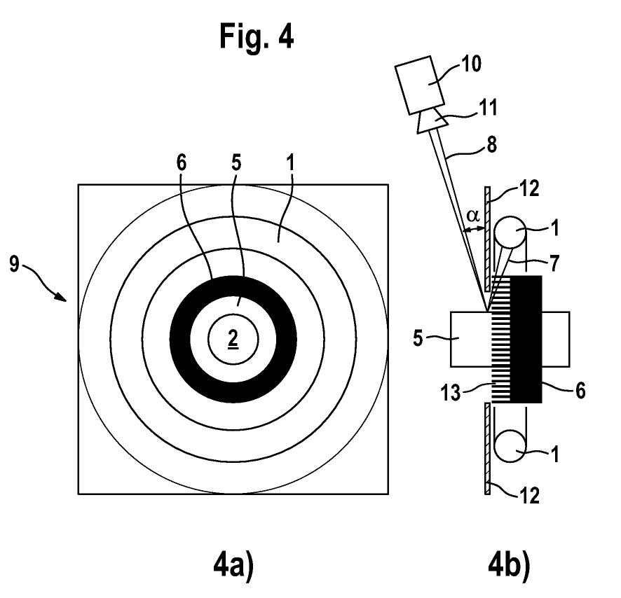

FIG. 4a shows an embodiment of an illuminating device 9. The cylindrical lighting unit 1, namely the lighting unit of the embodiment according to FIG. 1, illuminates the slit diaphragm 6. This slit diaphragm consists of a slit diaphragm according to FIG. 2. The lighting unit 1 and the slit diaphragm 6 are both realized cylindrically and arranged coaxially to one another. FIG. 3a shows a view of this arrangement in the longitudinal direction of the cylinder.

FIG. 4b shows the illuminating device 9 in the form of a side view, wherein the cylinder axis extends horizontally. The lighting unit 1 illuminates the slit diaphragm 6 with beams that are incident at an angle a referred to the surface normal of the object 5 to be inspected such that the emergent beams 8 can be decoupled at the rear end of the slit diaphragm 6. They are detected by a line scanning camera 10 with a diaphragm 11 arranged in front thereof. In order to improve the image contrast, a stray light shield 12 is assigned to the slit diaphragm 6 on the emergent side. The arrangement of the slits 13 (i.e., their length and position) is adapted to the outside diameter of the object to be inspected. The length of the slits in the longitudinal direction defines the brightness of the bright strips. If shorter slits are used, the brightness contrast between the bright and the dark strips is reduced. The position and the orientation of the slits perpendicular to the cylinder axis and the width of the slits are adapted to the geometry of the sought-after strip cluster such that all emergent light beams extend parallel to one another in the direction of the line scanning camera 10. A periodic strip pattern consisting of bright and dark strips is created in the camera image. A suitably selected wall thickness (e.g., 3 mm in the described embodiment), ensures that no stray light is projected into the camera image.

The structured illumination operates with a simple, non-coded pattern. The slits 13 produce strips of a known period that are projected along the cylinder axis. Three-dimensional structures and changes in the cylindrical shape of the object 5 to be inspected can be easily detected with this illumination.

The two essential types of defects, namely deformations and contaminations, can be detected simultaneously with the illuminating device 9 because both result in a deviation from the ideal strip pattern. It is described in greater detail below that the information on surface defects is contained in the brightness and that shape changes of dimensional defects are detected based on the curvature of the bright strips.

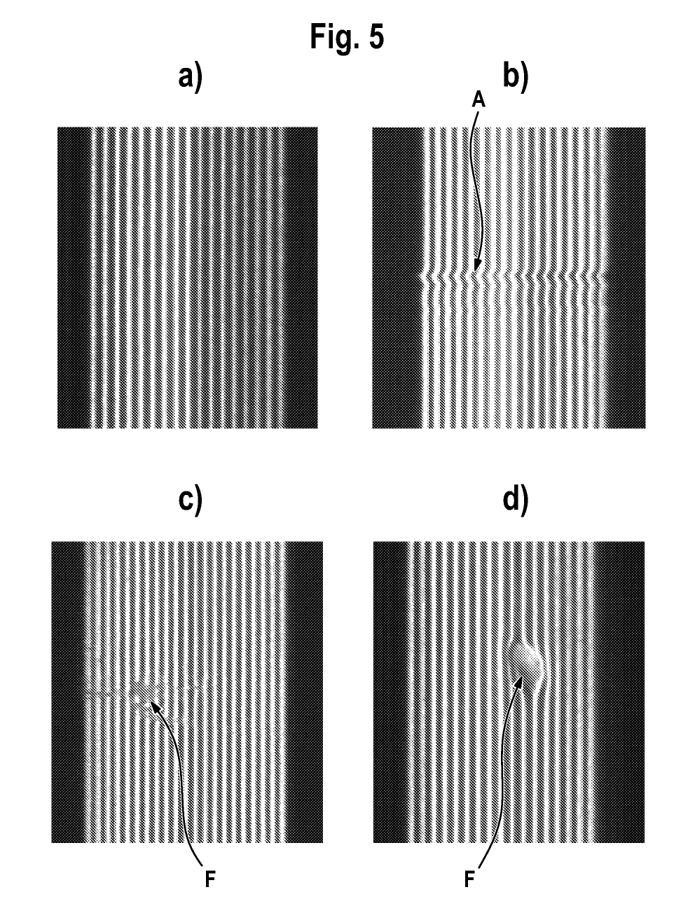

FIG. 5 shows strip patterns as they are detected by the line scanning camera 10 and displayed, for example, on a computer monitor. FIG. 5a shows a metallic surface of adequate quality, i.e., a surface without defects. The sequence of vertically extending bright and dark strips 10 is largely equidistant. The line scanning camera 10 used did not have to be calibrated for this image. In this and all other instances, surface areas without defects could be reliably distinguished from defective areas.

FIG. 5b shows the same surface as FIG. 5b, but contains artifacts A in the image center due to incorrect handling of the object during the measurement. A modification of the object handling (e.g., in the form of a movement or alignment of the object 5 to be inspected within the illuminating device 1) made it possible to either reduce the intensity of or completely eliminate artifacts on a surface that was known to have an adequate quality. Consequently, it was possible to distinguish defects from artifacts on unknown surfaces to be inspected.

FIG. 5c shows a surface image with a two-dimensional defect F (e.g., a (plane) paint contamination), wherein the object to be inspected shown in FIG. 5d features a three-dimensional defect F, namely a scratch.

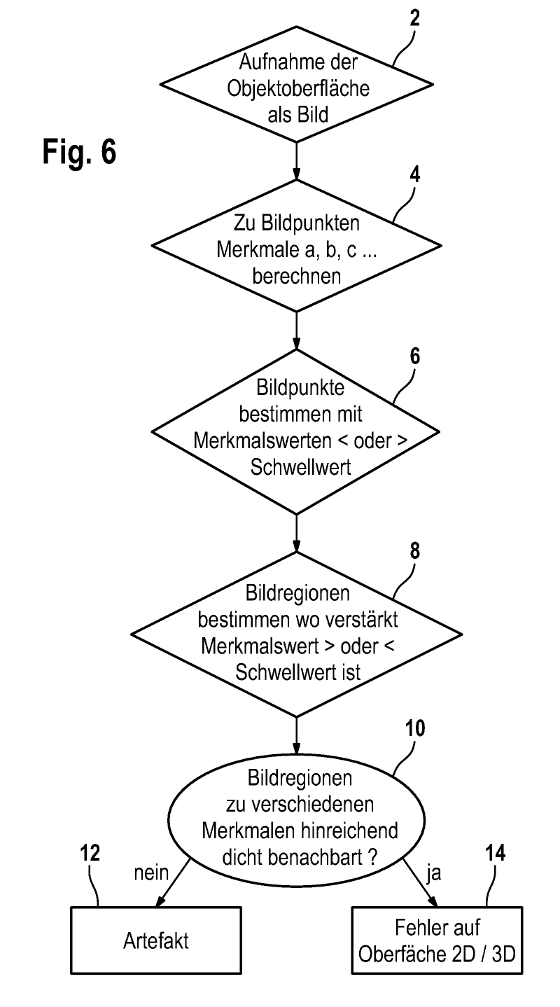

FIG. 6 shows a flow chart of the method for detecting defects on the surface of a cylindrical object. The method begins in step 2 by taking a photograph of the object surface. In this step 2, the cylindrical object is subjected to radiation that is able to produce a pattern of mutually adjacent bright and dark strips on a projection screen and the radiation reflected by the object surface is detected in a spatially resolved fashion, wherein the measured values are acquired in the form of an image. The spatially resolved detection can be carried out with a line scanning detector or a surface detector that scans the surface of the object to be inspected pixel-by-pixel. This results in a digital image such as, for example, an image according to FIGS. 5a-d that can be evaluated in a computer-assisted fashion.

In step 4, characteristics a, b, c, . . . etc. are calculated for all pixels or a portion of the pixels. The portion used may consist of the pixels that form the white strips, wherein the bright strips are identified based on the pixel intensities in this case. It is also possible to additionally calculate characteristics for the pixels that form the black strips, wherein the characteristics used in this case may differ from the initially cited characteristics a, b, c, . . . etc. The characteristics may consist of the distance of the pixel from a selected point of the image, the radiation intensity detected at the pixel location and/or the deviation of position between the pixel and a predetermined reference point within a mask placed over the image.

In step 6, the image elements or pixels with characteristic values that are higher or lower than a threshold value are determined. This is usually carried out for each characteristic, wherein a specific threshold value is defined for each characteristic. Due to this measure, the number of defined pixel quantities A, B, C, . . . etc. corresponds to the number of characteristics a, b, c, . . . etc.

In the next step 8, the image areas are determined, in which an increased density of the pixel quantities A, B, C, . . . etc. defined in step 6 is detected. Consequently, it is attempted to locate areas of the image, in which the pixels have characteristics that are higher or lower than a threshold value. These image areas represent possible defective areas.

In step 10, it is checked if the image areas with different characteristics a, b, c, . . . that were defined in step 8 adjoin sufficiently close. If this is not the case, it is deduced that an artifact was detected in step 12. However, if this is the case, the image areas that adjoin sufficiently close are part of a defect. The defective area can then be defined, for example, as the approximately rectangular image area that comprises the two closely adjoining image areas. In this case, it is also possible to distinguish whether the defect consists of a contamination (2D) or a deformation (3D) in dependence on the characteristic.

When choosing a characteristic, the changed value of which makes it possible to deduce that the white strips feature a local curvature (e.g., the distance of the pixel from a selected point of the image), the corresponding image area indicates a 3D-defect or a deformation in case of an overlap.

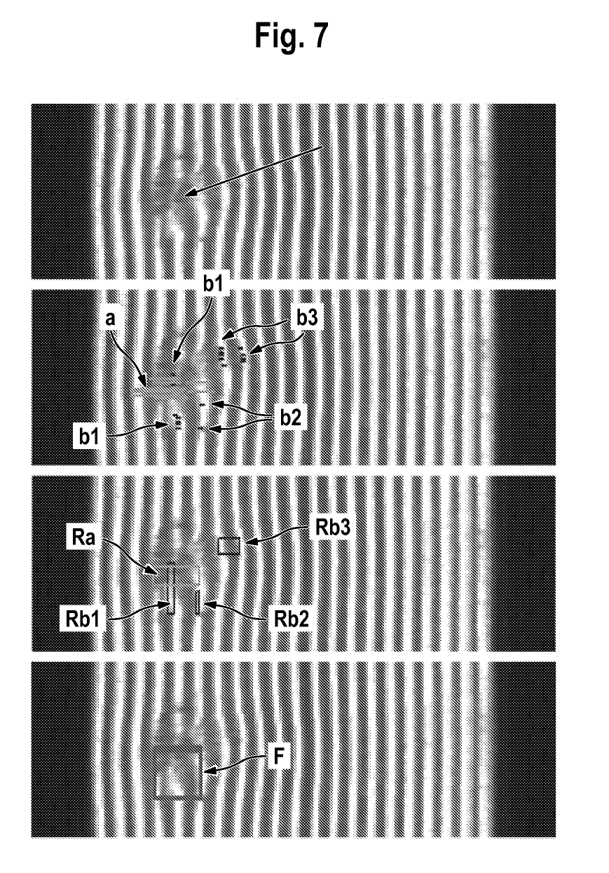

FIG. 7 shows the identification of defective areas by means of the present method based on four photographs. The top photograph in FIG. 7 shows the object surface according to step 2 of FIG. 6. The human observer would suspect a defect in the area identified by the arrow.

The same object surface is inspected for defects in a computer-assisted fashion based on two characteristics. These characteristics are:
a) the horizontal distance between two adjacent dark strips, wherein a dark strip is defined as being present at locations, at which the pixel intensity falls short of a predetermined threshold value; and
b) the horizontal shift of the bright strips for the pixels of a white strip.

There exist pixels, for which the characteristic a) exceeds a predetermined threshold value. The arrow identified with “a” points to these pixels. There also exist corresponding pixels, for which the characteristic b) exceeds a predetermined threshold value. The arrows identified with “b1”, “b2” and “b3” point to these pixels. The second photograph from the top therefore visualizes the result of step 6 in FIG. 6.

Subsequently, image areas with characteristics a) or b) that exceed their respective threshold value with increased frequency are determined in accordance with step 8 in FIG. 6. This is the image area Ra, in which the threshold value of characteristic a) is exceeded with increased frequency, as well as the image areas Rb1, Rb2 and Rb3, in which the threshold value of characteristic b) is exceeded with increased frequency.

Subsequently, it is checked if the image areas belonging to the two different characteristics a) and b) adjoin sufficiently close in the sense of step 10 in FIG. 6. Referred to the image area Ra, the image areas Rb1 and Rb2 adjoin sufficiently close, but not the image area Rb3. The criterion of a closely adjoining arrangement was checked based on the distance between the centers of the image areas that could not exceed a predetermined value. The defective area was determined in that a rectangle that encloses the image areas Ra and Rb1 was defined, as well as a rectangle that encloses the image areas Ra and Rb2. The arrow in the bottom photograph of FIG. 7 points to both rectangles that only have a slight vertical offset.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment of the invention, it being understood that various changes may be made in the function and arrangement of elements described in an exemplary embodiment without departing from the scope as set forth in the appended claims and their legal equivalents.

1. An illuminating device, comprising:
a cylindrical lighting unit;
a cylindrical slit diaphragm arranged in the interior of the cylindrical lighting unit, the cylindrical lighting unit comprising a cylindrical light source with a cylindrical diffusor arranged therein; and
a cylinder with axially extending slits that are arranged in such a way that incident beams coupled in perpendicular to a slit diaphragm axis (O) converge in a point (M) that is spaced apart from a cylinder axis in an interior of the cylindrical slit diaphragm through the axially extending slits.

2. The illuminating device according to claim 1, wherein the cylindrical lighting unit comprises at least three cylindrical light sources that are arranged within one another.

3. The illuminating device according to claim 1, wherein the cylindrical diffusor comprises at least three opaque bodies that are arranged within one another.

4. The illuminating device according to claim 1, wherein the cylindrical lighting unit and the cylindrical slit diaphragm are arranged coaxially to one another.

5. The illuminating device according to claim 1, wherein the cylindrical slit diaphragm has a wall thickness of at least about 3 mm.

6. A lighting unit, comprising;
a cylindrical light source with a luminous intensity of at least about 230.000 lux, and a cylindrical diffusor coaxially arranged within the cylindrical light source.

7. The lighting unit according to claim 6, wherein at least three cylindrical light sources are provided and arranged within one another.

8. The lighting unit according to claim 6, further comprising a diffusor comprising at least 3 opaque plastic bodies that are arranged coaxially to one another.

9. A slit diaphragm of cylindrical design comprising
axially extending slits arranged in such a way that incident beams coupled in perpendicular to a slit diaphragm axis (O) converge in a point (M) that is spaced apart from a cylinder axis in an interior of the slit diaphragm through the axially extending slits.

10. A method for detecting defects on the surface of a cylindrical object, wherein said method comprises the following steps:
subjecting the cylindrical object to radiation that is able to produce a pattern of mutually adjacent bright and dark strips on a projection screen;
detecting the radiation reflected by the surface of the cylindrical object in a spatially resolved fashion and acquiring measured values in the form of an image;
calculating a multitude of characteristics for at least a portion of each pixel of the image;
identifying pixels, at which the value of a characteristic lies at least one of above an below a predetermined threshold value;
identifying image areas in which identified pixels of each pixel of the image exceed a predetermined density; and
identifying a defect in areas of the image belonging to at least two different characteristics adjoin sufficiently close.

11. The method according to claim 10, wherein characteristics are only calculated for pixels that were subjected to radiation with a minimum intensity.

12. The method according to claim 10, wherein
at least the distance of the pixel from a selected point of the image is chosen as characteristic.

13. The method according to claim 10, wherein the defect is identified as at least one of a contamination and as a deformation of the object in dependence on at least one selected characteristic.

14. The method according to claim 13, wherein it is deduced that the surface of the object contains a deformation if one of the corresponding characteristics in the areas of the image that adjoin sufficiently close is the deviation of position between the pixel and a predetermined reference point within a mask placed over the image.

15. A computer program product on a computer-readable medium, comprising computer-readable program means that lead a computer to carry out the following steps:
calculating a multitude of characteristics for each pixel of an image or a portion of the pixels of an image consisting of a pattern of mutually adjacent bright and dark strips;
identifying pixels, at which the value of one characteristic lies at least one of above and below a predetermined threshold value,
identifying image areas, in which the identified pixels exceed a predetermined density; and
d) identifying a defect in an area of the image belonging to at least two different characteristics adjoin sufficiently close.

16. The computer program product according to claim 15, wherein characteristics are only calculated for the pixels that were subjected to radiation with a minimum intensity.

17. The computer program product according to claim 15, wherein the defect is identified as at least one of a contamination and a deformation of the object in dependence on the characteristics.
